(19) United States
(12) Patent Application Publication
(10) Pub. No.: US 2007/0216757 A1
(43) Pub. Date: Sep. 20, 2007

(54) Laser beam scanning apparatus, image forming apparatus, and laser beam scanning method

(75) Inventors: Daisuke Ishikawa, Shizuoka-ken (JP); Koji Tanimoto, Shizuoka-ken (JP); Kenichi Komiya, Kanagawa-ken (JP); Yuji Inagawa, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/375,920

(22) Filed: Mar. 14, 2006

(51) Int. Cl. B41J 2/435

(52) U.S. Cl. 347/247

(57) ABSTRACT

A laser beam scanning apparatus according to the invention includes: a laser oscillating unit that outputs a laser beam; a laser beam scanning unit that performs scanning in a main scanning direction with a laser beam and irradiates the laser beam on a photosensitive member via an optical lens; an error signal generating unit that monitors, in a predetermined period, intensity of a laser beam outputted from the laser oscillating unit and generates an error signal of an error between output intensity of the laser oscillating unit and a predetermined output reference value; a correction signal generating unit that generates a correction signal for correcting output intensity of a laser beam according to a change in optical efficiency in the main scanning direction such that intensity of the laser beam in the main scanning direction on the photosensitive member is constant; and a laser control signal generating unit that holds, during the image formation period, a reference signal generated on the basis of the error signal and applies the correction signal to the reference signal to generate a laser control signal for determining intensity of a laser beam outputted from the laser oscillating unit. The correction signal generated by the correction signal generating unit is a correction signal for correcting sensitivity of the photosensitive member including a change in the sensitivity with time and is a correction signal for further applying correction corresponding to a change in optical efficiency in the main scanning direction to output intensity of a laser beam with the change in the sensitivity with time corrected.

### BACKGROUND OF THE INVENTION

1. Field of the Invention

The present invention relates to a laser beam scanning apparatus, an image forming apparatus, and a laser beam scanning method, and, more particularly to a laser beam scanning apparatus that scans a photosensitive drum included in an image forming apparatus such as a laser printer or a digital copying machine with a laser beam to form an electrostatic latent image, an image forming apparatus having the laser beam scanning apparatus, and a laser beam scanning method.

2. Description of the Related Art

In recent years, various image forming apparatuses such as a digital copying machine and a laser printer that perform image formation according to scanning exposure by a laser beam and an electrophotographic process have been developed.

These image forming apparatuses include a laser beam scanning apparatus that scans a photosensitive drum with a laser beam to form an electrostatic latent image on the photosensitive drum. The laser beam scanning apparatus includes a laser oscillating unit that generates a laser beam, a polygon mirror that reflects the laser beam outputted from the laser oscillating unit to the photosensitive drum to cause the laser beam to scan the photosensitive drum, and an f-θ lens.

Toner development is applied to the electrostatic latent image formed on the photosensitive drum. A toner developed image is finally transferred onto recording paper as a recorded image. Therefore, in order to form a uniform recorded image without unevenness, it is necessary to form an electrostatic latent image having uniform intensity on the photosensitive drum. It is important to stabilize intensity of the laser beam.

In general, the laser oscillating unit used in the laser beam scanning apparatus has an APC (Auto Power Control) function. Laser oscillation intensity is monitored by a photo-detector that is built in the laser oscillating unit or disposed near the laser oscillating unit. The laser oscillating unit is controlled to have a fixed output.

However, even if an output of the laser oscillating unit is fixed, intensity of a laser beam irradiated on a photosensitive member (the photosensitive drum) is not always constant. This is mainly because a transmission loss of the f-θ lens varies depending on an angle of incidence. In general, an angle of incidence of a laser beam to the f-θ lens is substantially vertical in the center of the f-θ lens. The laser beam is made incident obliquely at a larger angle in positions closer to the ends of the f-θ lens. As a result, a transmission loss of the f-θ lens is the smallest in the center and is larger in positions closer to the ends of the f-θ lens.

This means that, from the viewpoint of intensity of a laser beam irradiated on the photosensitive drum, the intensity is the largest in the center of the f-θ lens and is smaller in positions closer to the ends of the f-θ lens to be non-uniform with respect to a main scanning direction.

Conventionally, as a method of correcting such non-uniformity in the main scanning direction, a method of contriving thickness and types of a coating layer of the f-θ lens to optically uniformalize a transmission loss is adopted. Consequently, machining of the f-θ takes time. As a result, an increase in cost is caused.

On the other hand, a method of electrically correcting intensity of a laser beam with respect to the main scanning direction is also conceivable. For example, a Patent Document (JP 2000-71510A) discloses a technique for storing correction data in a memory in advance and changing an amount of light of a laser oscillating unit using this correction data in order to correct non-uniformity of intensity of a laser beam with respect to the main scanning direction.

Recently, a technique for increasing resolution of an image and a technique for increasing speed of printing have made great advances. Therefore, in order to adapt the image forming apparatus to these techniques, it is necessary to perform electric correction of a main scanning direction extremely rapidly.

In general, it is known that sensitivity of a photosensitive member gradually falls as use time of the photosensitive member elapses. Conventionally, considering that such a change in characteristics with time is feeble, no specific measures are taken in many cases.

However, a quality of an image formed by the image forming apparatus is significantly improved according to the development of techniques such as a technique for increasing resolution of an image. Therefore, there is increasing necessity for applying careful correction to the change in characteristics with time and maintaining a high quality of an image.

### SUMMARY OF THE INVENTION

The invention has been devised in view of the circumstances and it is an object of the invention to provide a laser beam scanning apparatus, an image forming apparatus, and a laser beam scanning method that can fix laser beam intensity in a main scanning direction on a photosensitive drum and correct a change in characteristics with time such as a fall of sensitivity of a photosensitive member.

In order to attain the object, a laser beam scanning apparatus according to an aspect of the invention includes: a laser oscillating unit that outputs a laser beam; a laser beam scanning unit that performs scanning in a main scanning direction with a laser beam and irradiates the laser beam on a photosensitive member via an optical lens; an error signal generating unit that monitors, in a predetermined period, intensity of a laser beam outputted from the laser oscillating unit and generates an error signal of an error between output intensity of the laser oscillating unit and a predetermined output reference value; a correction signal generating unit that generates a correction signal for correcting output intensity of a laser beam according to a change in optical efficiency in the main scanning direction such that intensity of the laser beam in the main scanning direction on the photosensitive member is constant; and a laser control signal generating unit that holds, during the image formation period, a reference signal generated on the basis of the error signal and applies the correction signal to the reference signal to generate a laser control signal for determining intensity of a laser beam outputted from the laser oscillating unit. The correction signal generated by the correction signal generating unit is a correction signal for correcting sensitivity of the photosensitive member including a change in the sensitivity with time and is a correction signal for further applying correction corresponding to a change in optical efficiency in the main scanning direction to output intensity of a laser beam with the change in the sensitivity with time corrected.

Further, in order to attain the object, an image forming apparatus according to another aspect of the invention includes: a photosensitive member; a laser beam scanning apparatus that scans the photosensitive member with a laser beam in order to form an electrostatic latent image on the photosensitive member; a developing unit that applies toner development to the photosensitive member on which an electrostatic latent image is formed and generates a developed image; and a fixing unit that fixes the developed image. The laser beam scanning apparatus includes: a laser oscillating unit that outputs a laser beam; a laser beam scanning unit that performs scanning in a main scanning direction with a laser beam and irradiates the laser beam on a photosensitive member via an optical lens; an error signal generating unit that monitors, in a predetermined period, intensity of a laser beam outputted from the laser oscillating unit and generates an error signal of an error between output intensity of the laser oscillating unit and a predetermined output reference value; a correction signal generating unit that generates a correction signal for correcting output intensity of a laser beam according to a change in optical efficiency in the main scanning direction such that intensity of the laser beam in the main scanning direction on the photosensitive member is constant; and a laser control signal generating unit that holds, during the image formation period, a reference signal generated on the basis of the error signal and applies the correction signal to the reference signal to generate a laser control signal for determining intensity of a laser beam outputted from the laser oscillating unit. The correction signal generated by the correction signal generating unit is a correction signal for correcting sensitivity of the photosensitive member including a change in the sensitivity with time and is a correction signal for further applying correction corresponding to a change in optical efficiency in the main scanning direction to output intensity of a laser beam with the change in the sensitivity with time corrected.

Furthermore, in order to attain the object, a laser beam scanning method according to an aspect of the invention includes: outputting a laser beam from a laser oscillating unit; scanning in a main scanning direction with a laser beam and irradiating the laser beam on a photosensitive member via an optical lens; monitoring, in a predetermined period, intensity of a laser beam outputted from the laser oscillating unit; generating an error signal of an error between output intensity of the laser oscillating unit and a predetermined output reference value; generating a correction signal for correcting output intensity of a laser beam according to a change in optical efficiency in the main scanning direction such that intensity of the laser beam in the main scanning direction on the photosensitive member is constant; and holding a reference signal generated on the basis of the error signal during the image formation period,; applying the correction signal to the reference signal to generate a laser control signal for determining intensity of a laser beam outputted from the laser oscillating unit, wherein the correction signal generated in the generating the correction signal step is a correction signal for correcting sensitivity of the photosensitive member including a change in the sensitivity with time and is a correction signal for further applying correction corresponding to a change in optical efficiency in the main scanning direction to output intensity of a laser beam with the change in the sensitivity with time corrected.

According to the laser beam scanning apparatus, the image forming apparatus, and the laser beam scanning method according to the invention, it is possible to fix laser beam intensity in a main scanning direction on a photosensitive drum and correct a change in characteristics with time such as a fall in sensitivity of a photosensitive member.

### BRIEF DESCRIPTION OF THE DRAWINGS

In the accompanying drawings:

FIG. 1 is a schematic diagram of an image forming apparatus according to an embodiment of the invention;

FIG. 2 is a diagram showing a constitution of an optical system unit and a positional relation of a photosensitive drum;

FIG. 3 is a block diagram showing an example of a functional constitution mainly for controlling an optical system (a two-beam image forming apparatus);

FIG. 4 is a block diagram showing an example of a functional constitution mainly for controlling an optical system (a four-beam color tandem image forming apparatus);

FIG. 5 is a block diagram showing an example of a detailed constitution according to a first embodiment (A) for performing correction with time (a two-beam image forming apparatus);

FIG. 6 is a block diagram showing an example of a detailed constitution according to a second embodiment (A) for performing correction with time (a four-beam color tandem image forming apparatus);

FIG. 7 is a diagram showing a positional relation between an f-θ lens and a photosensitive drum;

FIG. 8 is a relational diagram of laser power on a surface of a photosensitive drum and a beam position (before correction);

FIG. 9 is a relational diagram of a laser power output and a beam position;

FIG. 10 is a relational diagram of laser power on a surface of a photosensitive drum and a beam position (after correction);

FIG. 11 is a block diagram showing an example of a detailed constitution according to a first embodiment (B) for performing correction with time and correction on a main scanning direction (a two-beam image forming apparatus);

FIG. 12 is a block diagram showing an example of a detailed constitution according to a second embodiment (B) for performing correction with time and correction of a main scanning direction (a four-beam color tandem image forming apparatus);

FIG. 13 is a diagram showing laser power on the surface of the photosensitive drum (before correction: initial state);

FIG. 14 is a diagram showing laser power on the surface of the photosensitive drum (after correction of a loss with time: initial state);

FIG. 15 is a diagram showing laser power on the surface of the photosensitive drum (before correction: elapsed time T1);

FIG. 16 is a diagram showing laser power on the surface of the photosensitive drum (after correction of a loss with time: elapsed time T1);

FIG. 17 is a diagram showing laser power on the surface of the photosensitive drum (before correction: elapsed time T2);

FIG. 18 is a diagram showing laser power on the surface of the photosensitive drum (after correction of a loss with time: elapsed time T2);

FIG. 19 is a diagram showing a laser power output (correction of a loss with time and a main scanning direction: simple addition correction, initial state);

FIG. 20 is a diagram showing laser power on the surface of the photosensitive drum (correction of a loss with time and a main scanning direction: simple addition correction, initial state);

FIG. 21 is a diagram showing a laser power output (correction of a loss with time and a main scanning direction: simple addition correction, elapsed time T1);

FIG. 22 is a diagram showing laser power on the surface of the photosensitive drum (correction of a loss with time and a main scanning direction: simple addition correction, elapsed time T1);

FIG. 23 is a diagram showing a laser power output (correction of a loss with time and a main scanning direction: simple addition correction, elapsed time T2);

FIG. 24 is a diagram showing laser power on the surface of the photosensitive drum (correction of a loss with time and a main scanning direction: simple addition correction, elapsed time T2);

FIG. 25 is a diagram showing a laser power output (correction of a loss with time and a main scanning direction: adaptive correction, initial state);

FIG. 26 is a diagram showing a laser power output (correction of a loss with time and a main scanning direction: adaptive correction, elapsed time T1);

FIG. 27 is a diagram showing a laser power output (correction of a loss with time and a main scanning direction: adaptive correction, elapsed time T2);

FIG. 28 is a diagram showing laser power on the surface of the photosensitive drum (correction of a loss with time and a main scanning direction: adaptive correction, initial state/elapsed time T1/elapsed time T2);

FIG. 29 is a block diagram showing an example of a detailed constitution according to a first embodiment (C) for performing correction with time and correction of a main scanning direction (a two-beam image forming apparatus);

FIG. 30 is a block diagram showing an example of a detailed constitution according to a first embodiment (D) for performing correction with time and correction of a main scanning direction (the two-beam image forming apparatus);

FIG. 31 is a block diagram showing an example of a detailed constitution according to a second embodiment (C) for performing correction with time and correction of a main scanning direction (a four-beam color tandem image forming apparatus); and

FIG. 32 is a block diagram showing an example of a detailed constitution according to a second embodiment (D) for performing correction with time and correction of a main scanning direction (the four-beam color tandem image forming apparatus).

### DESCRIPTION OF THE PREFERRED EMBODIMENTS

A laser beam scanning apparatus, an image forming apparatus, and a laser beam scanning method according to the invention will be explained with reference to the accompanying drawings.
(1) Constitutions of the Image Forming Apparatus and the Laser Beam Scanning Apparatus and Basic Operations Thereof

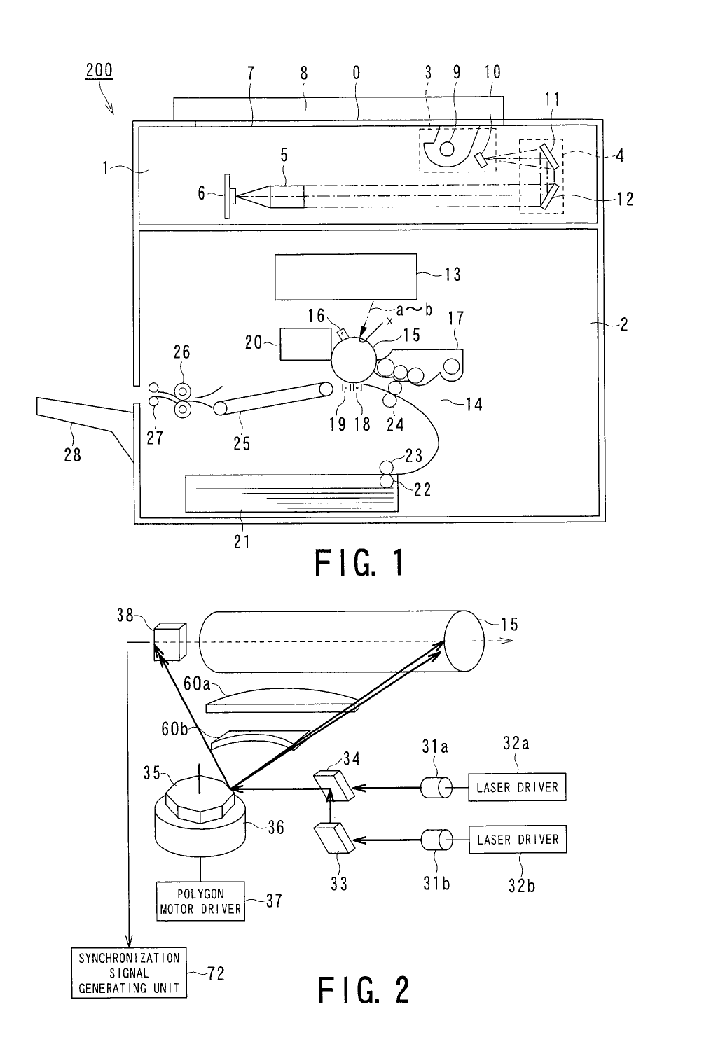

FIG. 1 is a diagram schematically showing an example of a constitution of an image forming apparatus 200, for example, a digital copying machine, to which a laser beam scanning apparatus 100 according to an embodiment of the invention is applied.

The image forming apparatus 200 includes a scanner unit 1 and a printer unit 2. In the scanner unit 1, an original 0 is placed face-down on original stand glass 7. The original 0 is pressed on the original stand glass 7 when a cover 8 for fixing an original provided to be freely opened and closed is closed.

The original 0 is irradiated by a light source 9. Reflected light from the original 0 is focused on a sensor surface of a photoelectric conversion element 6 via mirrors 10, 11, and 12 and a condensing lens 5. When a first carriage 3 including the light source 9 and the mirror 10 and a second carriage 4 including the mirrors 11 and 12 are moved in a direction from the right to the left in synchronization with a reading timing signal by a not-shown carriage driving motor to always fix an optical path length, an irradiated light from the light source 9 scans the original 0.

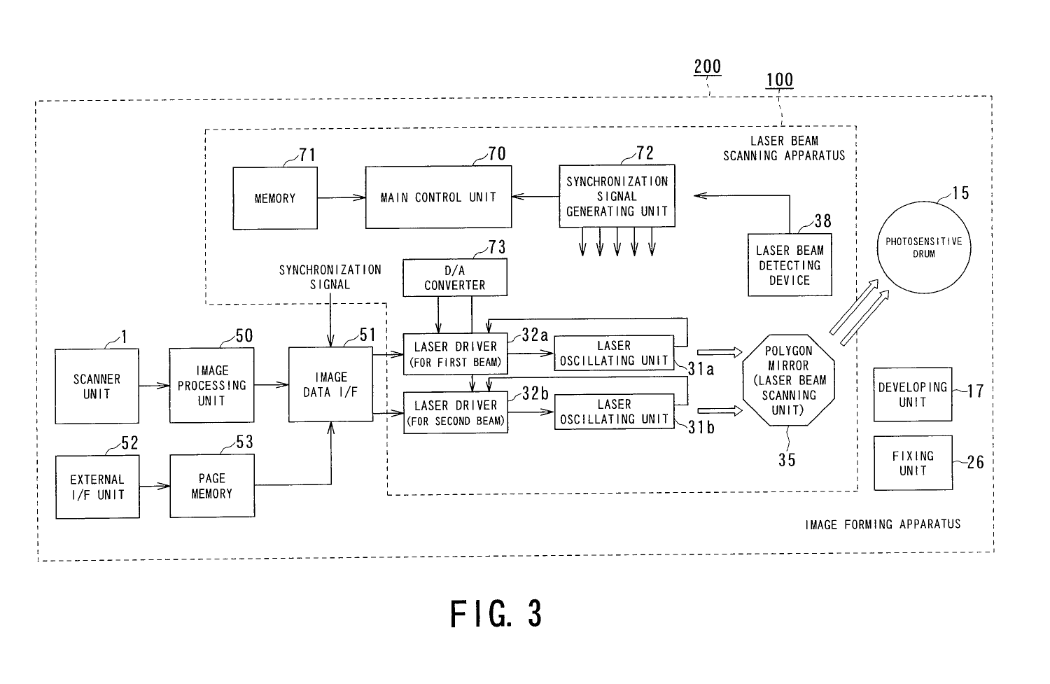

According to the scanning of the irradiated light, the original 0 placed on the original stand glass 7 is sequentially read line by line and converted into an analog electric signal corresponding to intensity of the reflected light by the photoelectric conversion element 6. Thereafter, the analog electric signal is converted into a digital signal indicating light and shade of an image by an image processing unit 50 (see FIG. 3) and outputted to a laser optical system unit 13.

The printer unit 2 includes the optical system unit 13 and an image forming unit 14 combined with an electrophotographic system capable of forming an image on a sheet P serving as a medium on which an image is formed. An image signal read from the original 0 by the scanner unit 1 is converted into a digital signal by the image processing unit 50 and, then, converted into a laser beam (hereinafter simply referred to as beam) from a semiconductor laser oscillator (a laser oscillating unit).

One or plural laser oscillating units provided in the optical system unit 13 perform light emission operation in accordance with a laser modulation signal outputted from the image processing unit 50 and generates beams. These beams are reflected by a polygon mirror to be scanning light and outputted to the outside of the unit. A detailed constitution of the optical system unit 13 will be described later.

The beams outputted from the optical system unit 13 are focused as spot light having necessary resolution at a point of an exposure position X on a photosensitive drum (a photosensitive member) 15 serving as an image bearing member and scans the photosensitive drum 15 in a main scanning direction (a rotation axis direction of the photosensitive drum). When the photosensitive drum 15 further rotates, an electrostatic latent image corresponding to the image signal is formed on the photosensitive drum 15.

Around the photosensitive drum 15 serving as an image bearing member for forming an image, a charger 16 that charges the surface of the photosensitive drum 15, a developing device (a developing unit) 17, a transfer charger 18, a peeling charger 19, and a cleaner 20 are arranged. The photosensitive drum 15 is driven to rotate at predetermined outer peripheral speed by a not-shown driving motor and charged by the charger 16 provided to be opposed to the surface of the photosensitive drum 15. The beams are spot-focused side by side in a sub-scanning direction (a direction in which the surface of the photosensitive drum moves) at the point of the exposure position X on the photosensitive drum 15 charged.

When light is irradiated on the exposure position X on the photosensitive drum 15 charged, a potential in that portion drops and the dropping potential forms an image. In other words, an electrostatic latent image is formed. A toner serving as a developer from the developing unit 17 is used for development by the photosensitive drum 15. A toner image is formed on the photosensitive drum 15 by the development. The toner image is transferred onto the sheet P, which is supplied from a sheet feeding system, at a point of a transfer position by the transfer charger 18.

The sheet feeding system separates the sheets P in a sheet feeding cassette 21 provided in the bottom section one by one with a sheet feeding roller 22 and a separating roller 23. Thereafter, the sheet P is sent to a registration roller 24 and supplied to the transfer position at predetermined timing. A sheet conveying mechanism 25, a fixing device (a fixing unit) 26, and a discharge roller 27 that discharges the sheet P on which an image is formed are arranged on a downstream side of the transfer charger 18. In the fixing device 26, the toner image is fixed on the sheet P on which the toner image is transferred. Thereafter, the sheet P is discharged to a sheet discharge tray 28 on the outside through the sheet discharge roller 27.

A residual toner on the photosensitive drum 15, which has completed the transfer of the image onto the sheet P, is removed by the cleaner 20. The photosensitive drum 15 returns to an initial state and comes into a standby state for the next image formation. An image forming operation is continuously performed by repeating the process operation described above.

The optical system unit 13 will be explained.

FIG. 2 shows a constitution of the optical system unit 13 and a positional relation of the photosensitive drum 15. The optical system unit 13 includes two laser oscillating units 31a and 31b. Two beams outputted from the respective laser oscillating units 31a and 31b simultaneously perform image formation for two scan lines at a time. This makes it possible to perform image formation at high speed without increasing the rotating speed of a polygon mirror 35.

The laser oscillating unit 31a is driven by a laser driver 32a on the basis of data modulated by a pulse width modulation system. A beam outputted from the laser oscillating unit 31a passes through a not-shown collimator lens and, then, passes through a half mirror 34 to be made incident on the polygon mirror 35 serving as a rotary polygon mirror.

The polygon mirror 35 is rotated at constant speed by a polygon motor 36 driven by a polygon motor driver 37. Consequently, reflected light from the polygon mirror 35 changes into a scanning light at a constant angular speed set by the polygon motor 36, passes through f-θ lenses 60a and 60b, and scans a light-receiving surface of a laser beam detecting device 38 and the surface of the photosensitive drum 15 at constant speed.

Similarly, the laser oscillating unit 31b is driven by a laser driver 32b on the basis of data modulated by the pulse width modulation system. A beam outputted from the laser oscillating unit 31b is made incident on a reflection mirror 33 after passing through the not-shown collimator lens. The beam reflected by the reflection mirror 33 passes through the half mirror 34 to be made incident on the polygon mirror 35. As an optical path after the polygon mirror 35, as in the case of the laser oscillating unit 31a, the beam passes through a not-shown f-θ lens and scans the light-receiving surface of the laser beam detecting device 38 and the surface of the photosensitive drum 15.

The laser drivers 32a and 32b have an Auto Power control (APC) function, respectively, and cause the laser oscillating units 31a and 31b to perform a light-emitting operation to keep a light-emission power level set by a main control unit 70 (see FIG. 3) consisting of a CPU or the like.

The respective beams outputted from the separate laser oscillating units 31a and 31b in this way are combined by the half mirror 34. Two beams travel in a direction of the polygon mirror 35.

The laser beam detecting device 38 detects passing timing of the two beams. The laser beam detecting device 38 is arranged near the end of the photosensitive drum 15 such that a position of the light-receiving surface is equivalent to a position of the surface of the photosensitive drum 15.

The laser beam detecting device 38 may be disposed such that the a beam used for scanning by the polygon mirror 35 is reflected using a not-shown return mirror and an extended line of the beam reflected by the return mirror and the light-receiving surface of the laser beam detecting device 38 are equivalent to the surface of the photosensitive drum 15.

Control for light-emitting timing (image formation position control in the main scanning direction) is performed on the basis of a detection signal from the laser beam detecting device 38. In order to generate a signal for performing these controls, a synchronization signal generating unit 72 is connected to the laser beam detecting device 38.

A control system will be explained.

FIG. 3 is a diagram showing an example of a functional constitution of the image forming apparatus 200 according to a first embodiment (A). In particular, an example of a functional constitution of the laser beam scanning apparatus 100 that perform scanning control for two beams (a multi-beam) is shown in detail.

The image forming apparatus 200 includes a scanner unit 1, the image processing unit 50, an image data I/F 51, the laser beam scanning apparatus 100, the photosensitive drum 15, a developing unit 17, and a fixing unit 26. Besides, the image forming apparatus 200 includes an external I/F unit 52 and a page memory 53.

The laser beam scanning apparatus 100 includes a main control unit 70, a memory 71, a synchronization signal generating unit 72, the laser beam detecting device 38, a D/A converter 73, the laser drivers 32a and 32b, the laser oscillating unit 31a and 31b, and the polygon mirror (a laser beam scanning unit) 35.

Operations of the image forming apparatus 200 constituted as described above will be schematically explained.

First, when the image forming apparatus 200 operates as a copying machine, an image of the original 0 (see FIG. 1) set on the original stand 7 is read by the scanner unit 1 and sent to the image processing unit 50. The image processing unit 50 applies image processing such as shading correction, various kinds of filtering processing, gradation processing, and gamma correction to an image signal from the scanner unit 1.

Image data outputted from the image processing unit 50 is sent to the image data I/F 51. The image data I/F 51 synchronizes the image data according to a synchronization signal generated by the synchronization signal generating unit 72 and divides and outputs the image data to the two laser drivers 32a and 32b.

The synchronization signal generating unit 72 generates a timing signal that synchronizes with timing at which respective beams pass over the laser beam detecting device 38. The image data is outputted from the image data I/F 51 to the respective laser drivers 32a and 32b in synchronization with this timing signal.

The synchronization signal generating unit 72 includes a generation circuit for a sampling signal for the APC function and a logic circuit for causing the laser oscillating units 31a and 31b to perform light-emitting operation when the respective beams pass over the laser beam detecting device 38 and detecting a main scanning direction point of the respective beams. The APC function means a function of forcibly causing the respective laser oscillating units 31a and 31b to perform light-emitting operation in a time period (hereinafter referred to as APC period because an APC operation is performed in this period) other than time when beams irradiate the image formation area on the photosensitive drum 15 and controlling output power of the respective beams on the basis of a monitor value at this time.

When the image data is transferred in synchronization with scanning of the respective beams using the synchronization signal outputted from the synchronization signal generating unit 72 in this way, image formation (in a correct position) synchronized in the main scanning direction is performed.

The image forming apparatus 200 is constituted to be capable of operating not only as the copying machine but also as a printer. In this case, the image forming apparatus 200 performs image formation using image data inputted from the outside via the external I/F 52 connected to the page memory 53. The image data inputted from the external I/F 52 is temporarily stored in the page memory 53 and, then, sent to the laser drivers 32a and 32b via the image data I/F 51.

The laser drivers 32a and 32b of the laser beam scanning apparatus 100 causes the laser oscillating units 31a and 31b to emit laser beams in accordance with the image data. Besides, the laser drivers 32a and 32b also have a function of forcibly performing the light-emitting operation of the laser oscillating units 31a and 31b regardless of the image data according to a forcible light emission signal from the main control unit 70.

The polygon mirror 35 is a mirror for using the two beams outputted from the laser oscillating units 31a and 31b to scan the photosensitive drum 15 in the main scanning direction. The two beams are repeatedly used for scanning the photosensitive drum 15 at high speed in the main scanning direction in a state in which the beams are arranged in parallel.

The rotational driving for the polygon mirror 35 is performed according to the control from the main control unit 70. Control signals for rotation start, rotation stop, and switching of the rotating speeds from the main control unit 70 are outputted to the polygon motor driver 37 (see FIG. 2) and drive to rotate the polygon motor 36.

An electrostatic latent image is formed on the photosensitive drum 15 by the beams irradiated on the photosensitive drum 15. This electrostatic latent image is developed by the developing unit 17. A developed image (a toner image) developed on the photosensitive drum 15 is transferred onto recording paper. Then, a toner is fixed on the recording paper by the fixing unit 26.

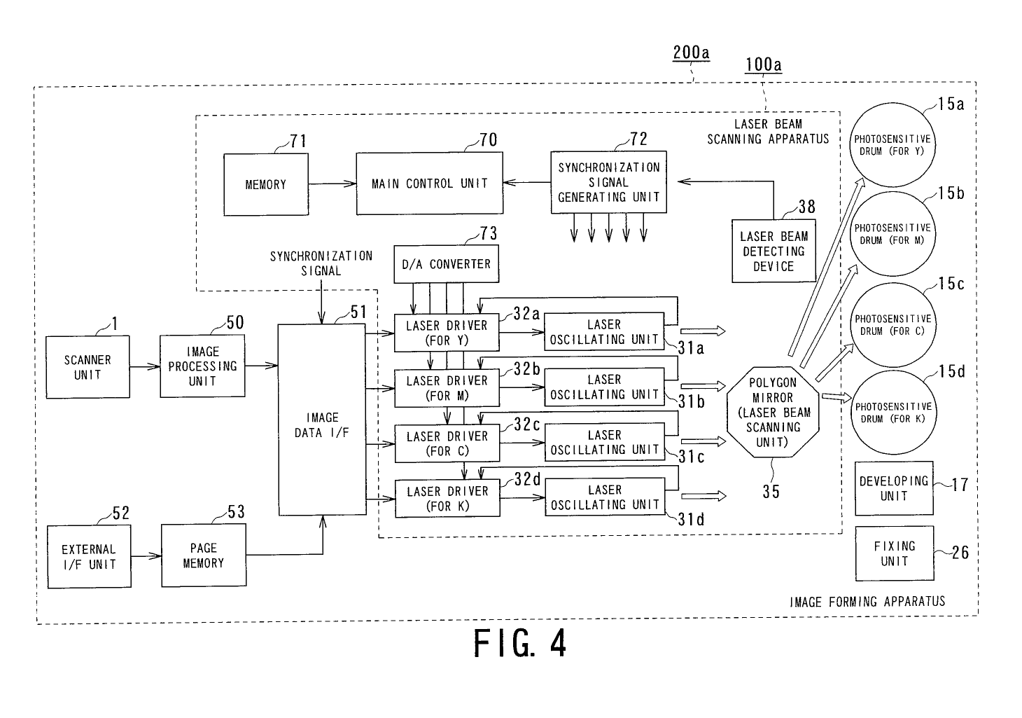

FIG. 4 is a diagram showing an example of a functional constitution of an image forming apparatus 200a according to a second embodiment (A).

A multi-beam system is also used for an image forming apparatus that forms a color image at high speed other than the system for irradiating two beams on one photosensitive drum 15 (the first embodiment). For example, the image forming apparatus includes four photosensitive drums for Y (yellow), M (magenta), C (cyan), and K (black) and irradiates independent four beams on the respective photosensitive drums to form a color image at high speed. The image forming apparatus of this form may be called as a color tandem image forming apparatus. The image forming apparatus 200a according to the second embodiment (A) corresponds to this color tandem image forming apparatus and simultaneously forms four beams.

A difference from the first embodiment (A) (the image forming apparatus 200 of the two beam system) is that four systems of laser drivers, laser oscillating units, and photosensitive drums are provided, respectively. Laser drivers 32a, 32b, 32c, and 32d, laser oscillating units 31a, 31b, 31c, and 31d, and photosensitive drums 15a, 15b, 15c, and 15d for Y, M, C, and K are provided. Other components are the same as those of the image forming apparatus 200 of the two beam system (FIG. 3).

In the image forming apparatuses 200 and 200a constituted as described above, in order to form a high-quality image, intensity setting for a beam irradiated on the photosensitive drum is extremely important.

In general, the image forming apparatuses 200 and 200a have the APC function as described above and are controlled such that a laser output at the not-signal time takes a predetermined fixed value. However, this alone is insufficient.

As described later, intensity of a beam irradiated on the photosensitive drum 15 is not uniform with respect to the main scanning direction (an axial direction of the photosensitive drum 15). The intensity is high in the center and is lower in a position closer to the end of the photosensitive drum 15. Therefore, in order to form a uniform image without unevenness on the photosensitive drum 15, it is necessary to correct intensity of the beam with respect to the main scanning direction.

Moreover, in order to maintain a recent high-quality image for a long period, a change in characteristics with time cannot be neglected. In particular, it is known that sensitivity of the photosensitive drum 15 gradually falls as use time of the photosensitive drum 15 elapses. In order to compensate for such a fall in sensitivity with time, correction for increasing intensity (an amount of light) of a beam according to the use time is also necessary.

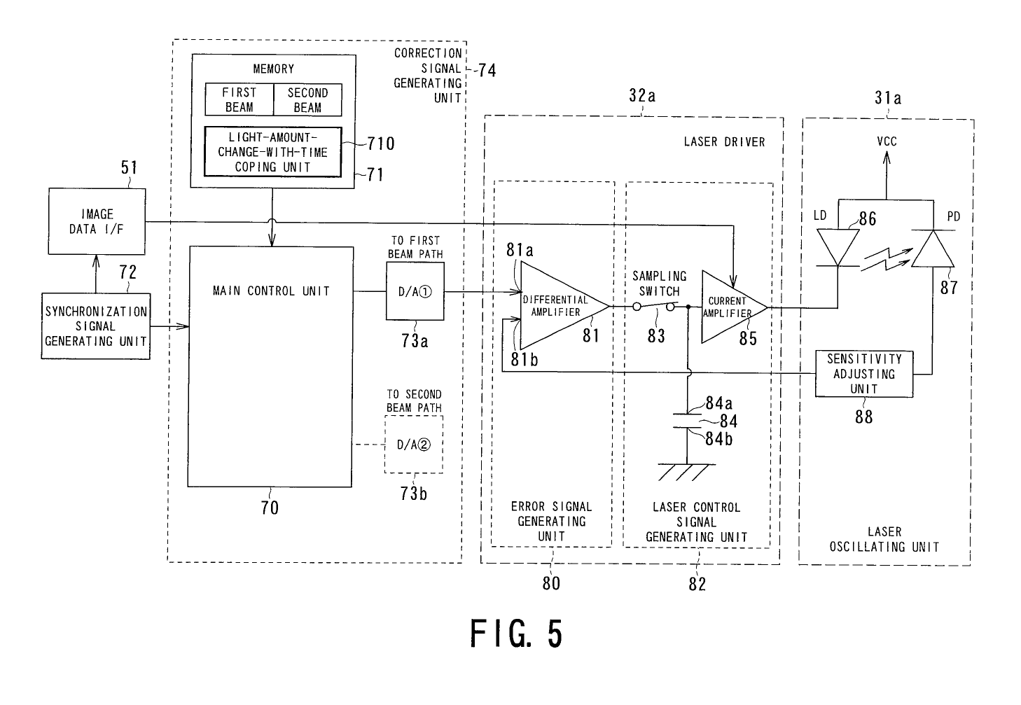

Thus, in the laser beam scanning apparatus 100 (100a) and the image forming apparatus 200 (200a) according to this embodiment, a correction signal for correcting intensity of a beam is generated by a correction signal generating unit 74 (including the main control unit 70, the memory 71, and the D/A converter 73; see FIG. 5). This correction signal is applied to the laser drivers 32a and 32b (or the laser drivers 32a, 32b, 32c, and 32d) to control amounts of light of the laser oscillating units 31a and 31b (or the laser oscillating units 31a, 31b, 31c, and 31d) such that laser power on the surface of the photosensitive drum 15 is constant.

In the following description, “laser power on the surface of the photosensitive drum 15” also includes an influence of sensitivity of the photosensitive drum 15 itself.
(2) Correction of a Change with Time

FIG. 5 is a diagram showing an example of detailed constitution for light amount control of the laser oscillating units 31a and 31b in the laser beam scanning apparatus 100 according to the first embodiment (A). Since systems for generating two beams (beams through a first beam path and a second beam path) have an identical constitution, the first beam path is explained as an example below.

The example of the constitution according to the first embodiment (A) shown in FIG. 5 is a form for correcting a change with time in laser power on the surface of the photosensitive drum 15.

An amount of light of the laser oscillating unit 31a is determined by the correction signal generating unit 74, an error signal generating unit 80 and a laser control signal generating unit 82 constituting the laser driver 32a, and the laser oscillating unit 31a.

Specifically, an amount of light of the laser oscillating unit 31a is determined by an amount of charges, that is, a voltage accumulated in a hold capacitor (a capacitor) 84 provided in the laser control signal generating unit 82. A current amplifier 85 of the laser control signal generating unit 82 converts a voltage at a charge/discharge terminal 84a of the hold capacitor 84 into an electric current and drives a laser diode 86 of the laser oscillating unit 31a with the electric current.

On the other hand, a sampling switch (a switch) 83 of the laser control signal generating unit 82 is controlled to be off (open) in a period of image formation and on (close) in the APC period.

A differential amplifier 81 constituting the error signal generating unit 80 outputs a difference (an error) between a voltage at a reference input terminal 81a thereof and a voltage at a differential input terminal 81b.

An output of a photo-detector 87 that is provided adjacent to the laser diode 86 and detects output power of the laser diode 86 is connected to the differential input terminal 81b via a sensitivity adjusting unit 88.

Therefore, during the APC period, charge and discharge are performed between the differential amplifier 81 and the hold capacitor 84 until output power of the laser diode 86 coincides with an output power value set by the voltage at the reference input terminal 81a of the differential amplifier 81 (an error is reduced to zero). Consequently, a voltage at the hold capacitor 84 is determined.

On the other hand, during the image formation period, since the sampling switch 83 is off, the voltage determined during the APC period is held as a voltage at the hold capacitor 84.

During the image formation period, the current amplifier 85 is switched according to image data (e.g., image data subjected to pulse width modulation) outputted from the image data I/F unit 51. An output current corresponding to an input voltage of the current amplifier 85 (i.e., a voltage at the charge/discharge terminal 84a of the hold capacitor 84) is switched (on and off) according to the image data to drive the laser diode 86 to emit light.

In this way, it is possible to set an amount of light during the image formation period according to a voltage at the reference input terminal 81a of the differential amplifier 81.

The voltage at the reference input terminal 81a is an output voltage of a D/A converter 73a. The output voltage of the D/A converter 73a is determined when the main control unit 70 reads out data stored in the memory 71 in advance and sets the data in the D/A converter 73a.

Therefore, it is possible to set output power of the laser diode 86 according to a value of the data stored in the memory 71.

As described above, it is known that laser power on the surface of the photosensitive drum 15 falls with time. An amount of the fall is also known according to actual measurement or the like.

Thus, in this embodiment, correction data for correcting a fall with time in laser power on the surface of the photosensitive drum 15 is stored in a light-amount-change-with-time coping unit 710 of the memory 71 in association with, for example, use time and an accumulated number of prints It is possible to maintain an amount of light of a beam at the time of start of use over a long period by setting the correction data corresponding to the use time and the accumulated number of prints in the D/A converter 73a.

Even when there is an individual difference in characteristics of the laser oscillating unit 31a and the laser oscillating unit 31b, it is possible to cope with the individual difference by storing independent correction data for a first beam and a second beam in the light-amount-change-with-time coping unit 710.

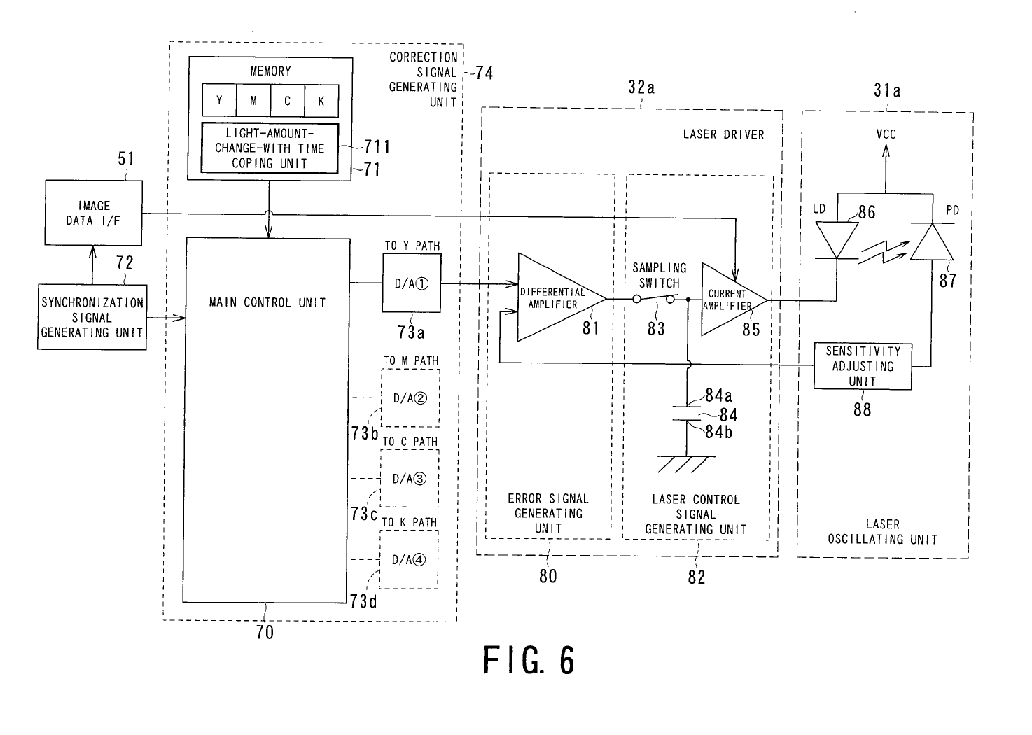

FIG. 6 is a diagram showing an example of a detailed constitution for light amount control for the laser oscillating units 31a, 31b, 31c, and 31d in the laser beam scanning apparatus 10a according to the second embodiment (A). In this embodiment, independent four beams are irradiated on four photosensitive drums for Y, M, C, and K. FIG. 6 shows only a path for Y among the beams and does not show the other paths.

As in the first embodiment (A), it is possible to correct a change with time in laser power on the surfaces of the respective photosensitive drums. Correction data is stored in a light-amount-change-with-time coping unit 711 of the memory 74. In this embodiment, as in the first embodiment (A), it is possible to perform correction conforming to characteristics of respective laser oscillating units and photosensitive drums for Y, M, C, and K by storing correction data corresponding to the respective paths in the light-amount-change-with-time coping unit 711.

Since detailed operations in FIG. 6 are the same as those explained with reference to FIG. 5, explanations of the operations are omitted.
(3) Correction of a Main Scanning Direction

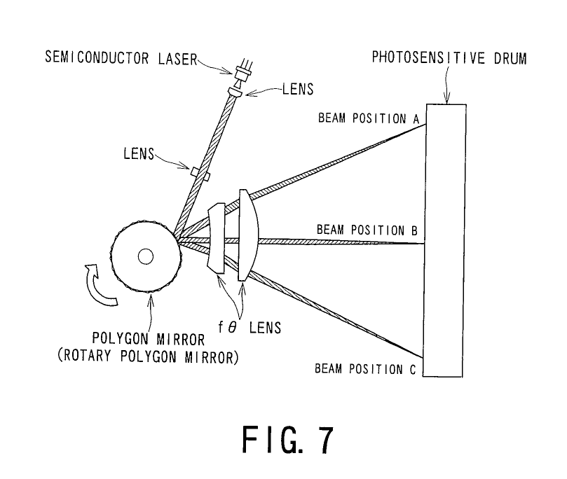

FIG. 7 is a diagram showing a path reaching from the laser oscillating unit 31 to the photosensitive drum 15.

An angle of incidence of a beam to the main scanning direction of the f-θ lens is close to vertical near the center of the lens (a beam position b). The laser beam is made incident obliquely at a larger angle in positions closer to the ends of the lens (beam positions A and C). Therefore, a transmission loss of the lens with respect to the main scanning direction in one line increases from the center of the lens to the ends of the f-θ lens. As a result, even if a laser power output of a laser beam source is fixed, laser power on the surface of a photosensitive drum is large in the center and small at the ends.

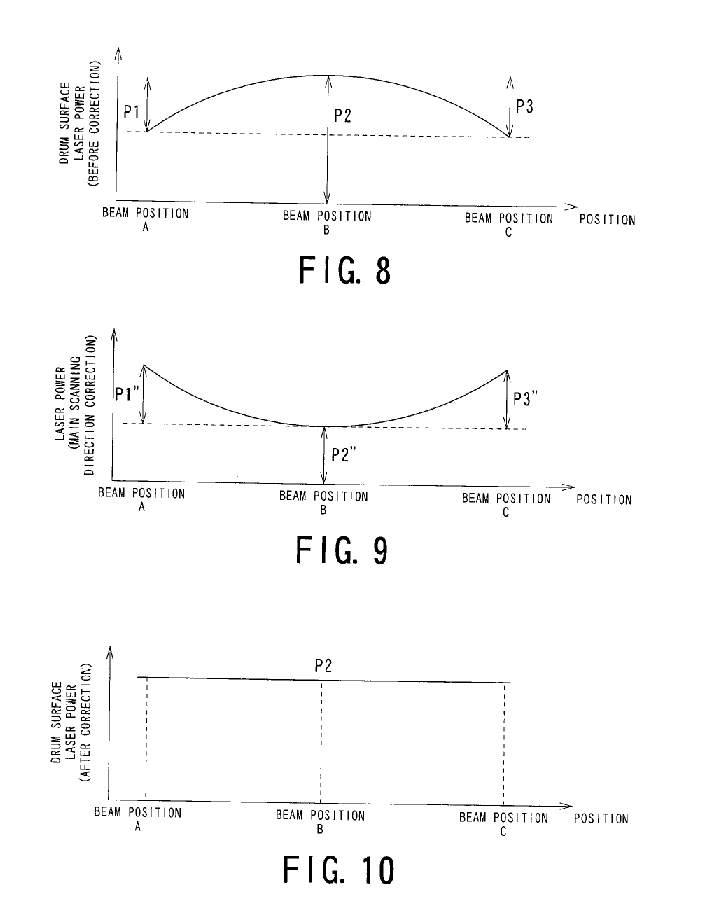

FIG. 8 is a diagram schematically showing this situation. The laser power on the surface of the photosensitive drum takes a maximum value P2 in the beam position B (the center). Losses of P1 and P3 occur at both the ends of the photosensitive drum (the beam positions A and C), respectively.

In order to correct the losses in the main scanning direction, as shown in FIG. 9, output power of the laser oscillator 31 only has to be corrected to be stronger from the center to both the ends.

As a result, it is possible to make the laser power on the surface of the photosensitive drum to be uniform with respect to the main scanning direction as shown in FIG. 10.

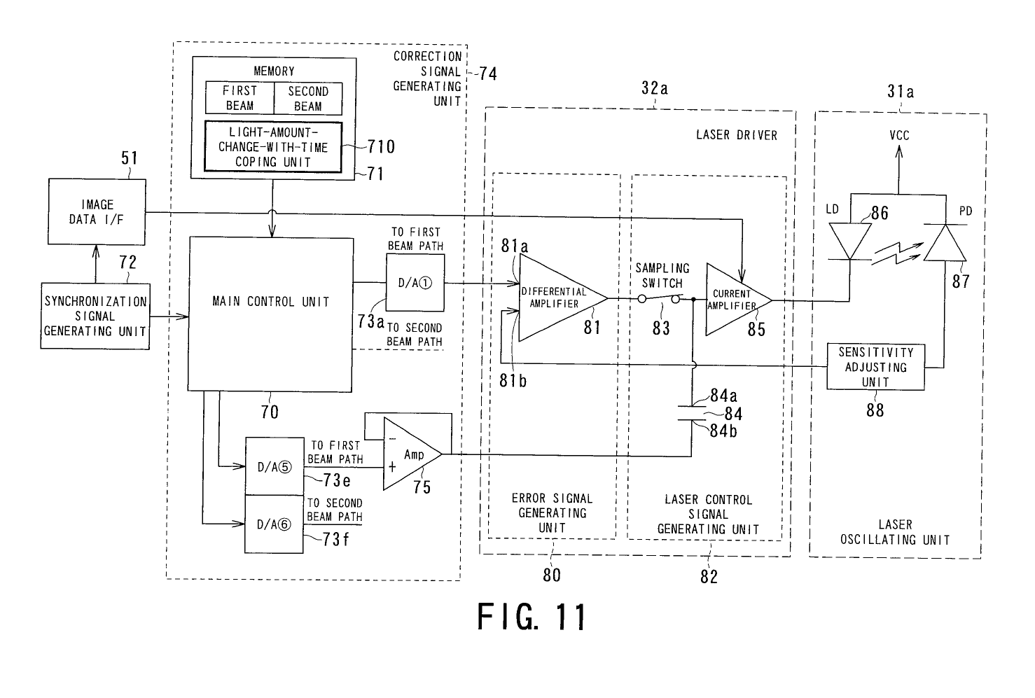

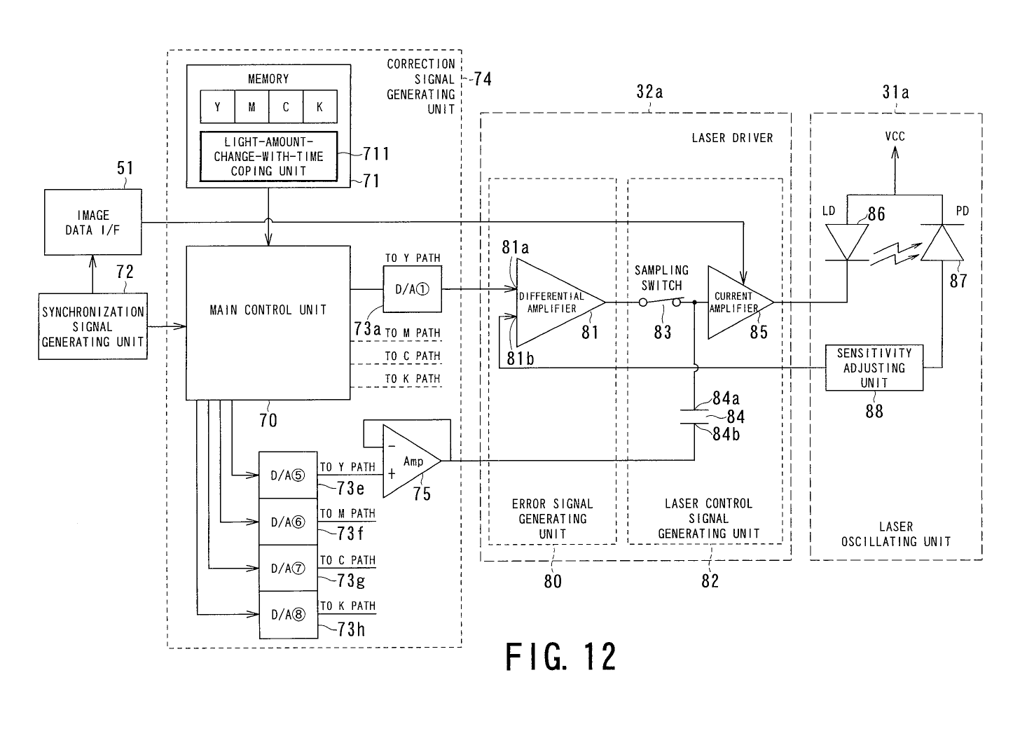

In this embodiment, the output power of the laser oscillator 31 is changed with respect to the main scanning direction using constitutions shown in FIGS. 11 and 12.

FIG. 11 is a diagram showing an example of a constitution corresponding to the image forming apparatus 200 of the two beam system (hereinafter referred to as first embodiment (B)). FIG. 12 is a diagram showing an example of a constitution corresponding to the image forming apparatus 200a of the four beam system (hereinafter referred to as second embodiment (B)). A correction method itself for a main scanning direction is the same in both the constitutions. This correction method will be explained using FIG. 11.

The first embodiment (A) and the first embodiment (B) are different in that, whereas a reference potential terminal 84b of the hold capacitor 84 is grounded in the first embodiment (A), the reference potential terminal 84b is connected to a D/A converter 73e via a buffer amplifier 75 in the first embodiment (B). The D/A converter 73e is connected to the main control unit 70.

In such a constitution, during image formation, correction data corresponding to FIG. 9 is outputted from the main control unit 70. A voltage obtained by subjecting this correction data to D/A conversion is applied to the reference potential terminal 84b of the hold capacitor 84 via the buffer amplifier 75. As a result, at the charge/discharge terminal 84a of the hold capacitor 84 (an input terminal of the current amplifier 85), a voltage value for change with time correction set by charge and discharge during the APC period and a voltage value for correction of a main scanning direction outputted from the main control unit 70 during the image formation period are superimposed. Thus, it is possible to simultaneously perform the correction of a change with time and the correction of a main scanning direction.
(4) Complex Correction of Correction of a Change with Time and Correction of a Main Scanning Direction

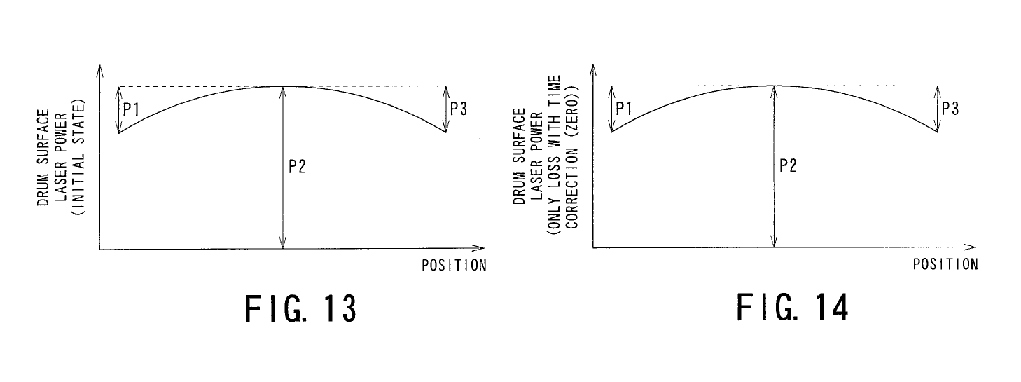

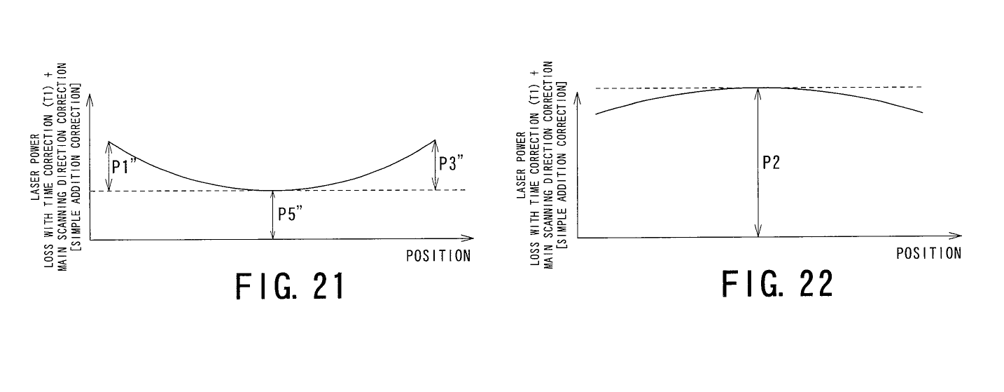

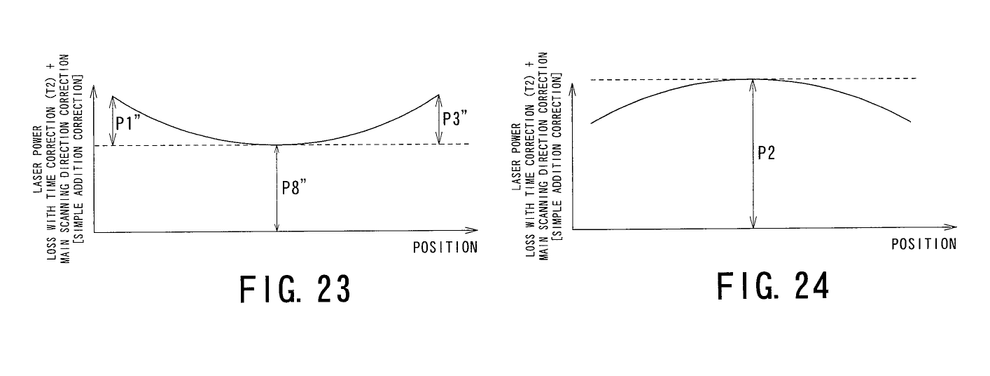

When correction of a change with time and correction of a main scanning direction are simultaneously performed, accurate correction cannot always be performed simply by adding correction value of both the corrections to correct the change with time and the main scanning direction. A reason for this will be explained using FIGS. 13 to 18 and FIGS. 19 to 24.

FIGS. 13 to 18 are diagrams in which laser power on the surface of a photosensitive drum before correction and after correction at the time when only correction with time is performed as correction.

FIGS. 13 and 14 are diagrams of an initial state in which sensitivity of the photosensitive drum does not fall. In this case, since correction with time is not performed, naturally, the laser power before correction and the laser power after correction coincide with each other. In addition, since correction of a main scanning direction is not performed, laser power on the surface of the photosensitive drum is not uniform in the main scanning direction.

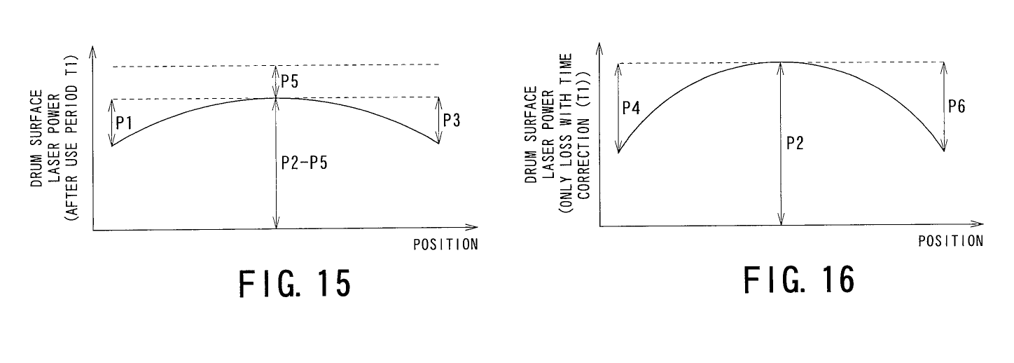

FIGS. 15 and 16 are diagrams showing laser power on the surface of the photosensitive drum before correction and after correction after a use period Ti.

As it is seen when FIG. 14 and FIG. 16 are compared, laser power in FIG. 14 and laser power in FIG. 16 on the surface of the photosensitive drum after correction coincide with each other in the center in the main scanning direction but do not coincide with each other in areas other than the center (P4≠P1, P6≠P3). This is because a change in laser power on the surface of the photosensitive drum in the main scanning direction is mainly caused by a change in transmittance of an f-θ lens and, even if transmittance is the same, if an absolute amount of laser power inputted to the f-θ lens increases, an absolute amount of a loss also increases.

In other words, in order to correct a fall in sensitivity with time, laser power inputted to the f-θ lens is larger in FIG. 16 than in FIG. 14. As a result, an absolute amount of a loss in FIG. 16 in the areas other than the center is larger, with respect to the same change in transmittance with that in the center as a reference.

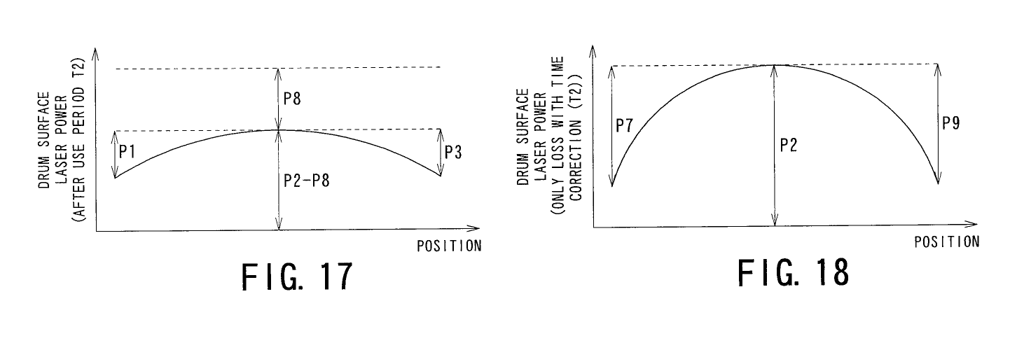

FIGS. 17 and 18 are diagrams showing laser power on the surface of the photosensitive drum before and after correction at use time T2 (>T1). In this case, since the fall in sensitivity with time increases, the laser power inputted to the f-θ lens increases compared with that in FIG. 16. As a result, an absolute value of a loss of laser power on the surface of the photosensitive drum at both the ends is larger even after correction.

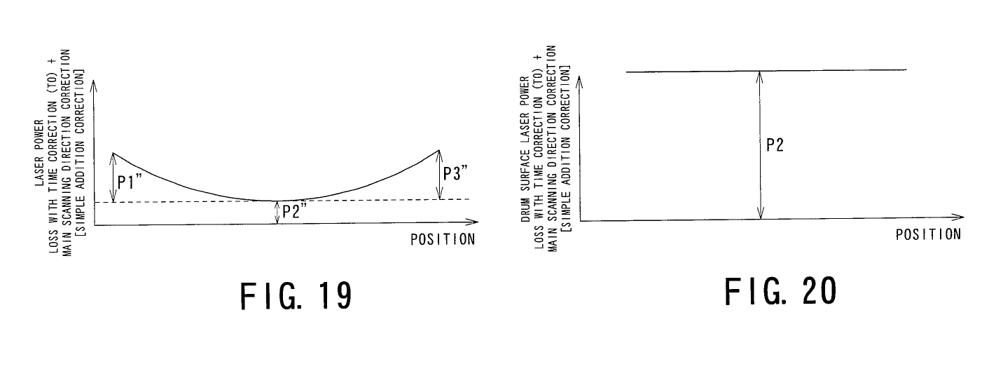

FIGS. 19 to 24 are diagrams illustrating a laser power output value and laser power on the surface of the photosensitive drum after correction in the case in which correction of a change with time and correction of a main scanning direction are simultaneously performed. In the correction shown in FIGS. 19 to 24, laser power is corrected by simply adding a correction value of a change with time and a correction value of a main scanning direction (i.e., one set of identical correction data is used for the correction value of a main scanning direction regardless of a value of the correction value of a change with time). In such simple addition correction, when the correction of a change with time is not performed, laser power is corrected to be a uniform value with respect to the main scanning direction as shown in FIG. 20. However, when the correction of a change with time is performed, a fall in laser power on the surface of the photosensitive drum occurs in the areas other than the center as shown in FIGS. 22 and 24. As a result, it is impossible to perform highly accurate correction.

As it is seen from the above explanation, when the correction of a change with time and the correction of a main scanning direction are simultaneously performed with high accuracy, it is necessary to perform the correction as correction with a shape of a correction curve in the main scanning direction varied to be adapted to a correction amount of a change with time (hereinafter referred to as adaptive correction).

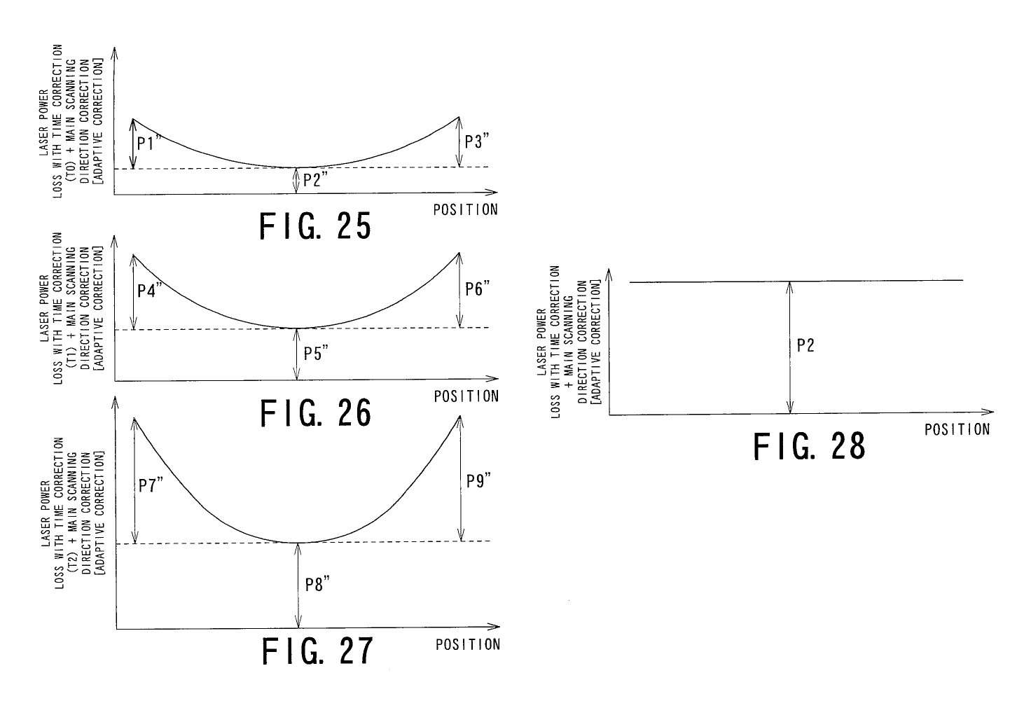

FIGS. 25 to 27 are diagrams showing an output value of laser power at the time when this adaptive correction is performed. FIG. 28 is a diagram showing laser power on the surface of the photosensitive drum after the adaptive correction.

FIG. 25 shows laser power in the main scanning direction immediately after the start of use (T0). Only the correction of a main scanning direction is substantially performed.

FIG. 26 shows laser power after the adaptive correction after elapsed time T1. A correction amount of a change with time is (P5″-P2″) and laser power inputted to the f-θ lens increases. In order to adapt laser power to this increase in laser power, laser power is larger at both ends of a correction curve in the main scanning direction.

FIG. 27 shows laser power after the adaptive correction after elapsed time T2. A correction amount of a change with time is (P8″-P2″) and laser power inputted to the f-θ lens further increases. In order to adapt laser power to this increase in laser power, laser power is larger than that at the elapsed time T1 at both ends of a correction curve in the main scanning direction.

FIG. 28 illustrates laser power on the surface of the photosensitive drum at the time when the adaptive correction is performed. Since a correction amount (a shape of a correction curve) in the main scanning direction is varied according to a correction amount of a change with time, as shown in FIG. 28, it is possible to always obtain constant laser power on the surface of the photosensitive drum without depending on elapsed time and the main scanning direction.

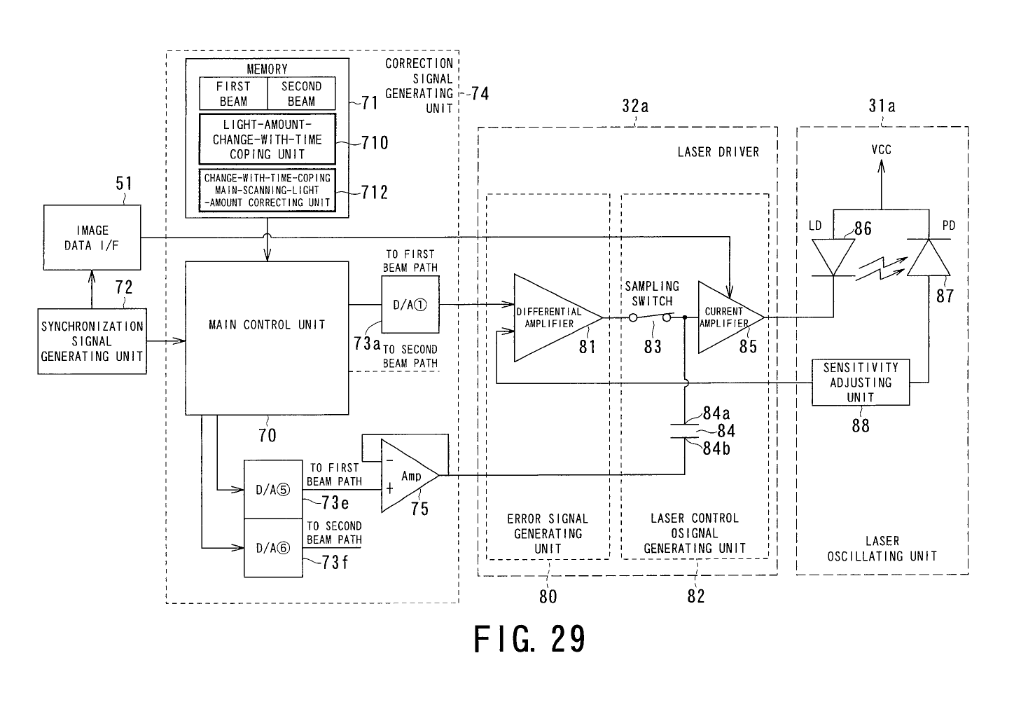

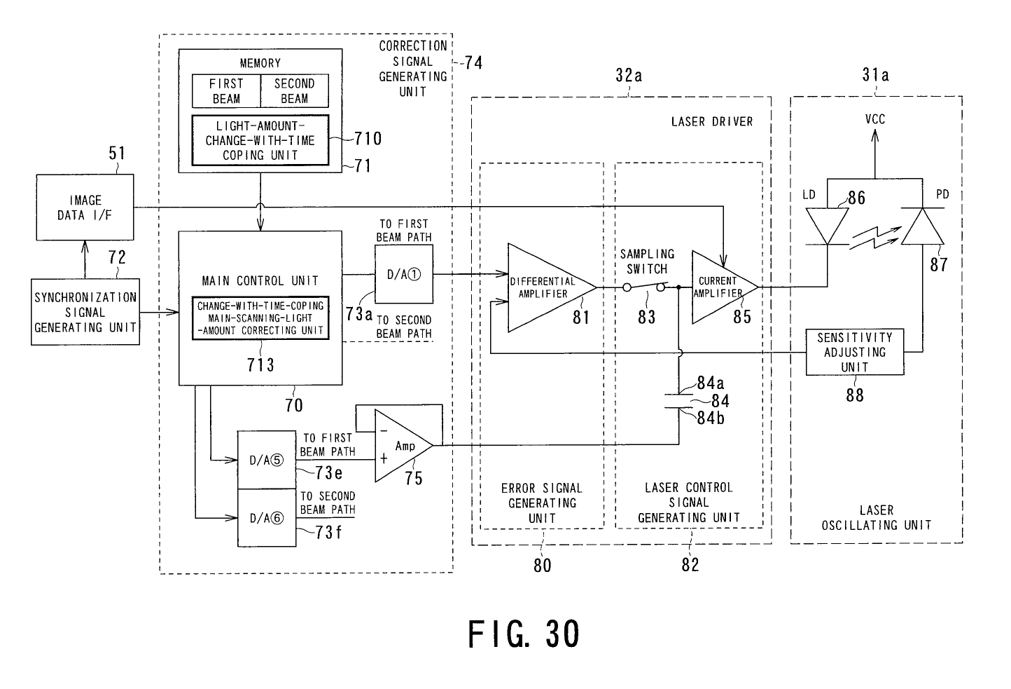

FIGS. 29 and 30 are diagrams showing examples of constitutions of the first embodiment (C) and the first embodiment (D) that realize the adaptive correction in the image forming apparatus 200 of the two beam system, respectively.

In the first embodiment (C) (FIG. 29), the light-amount-change-with-time coping unit 710 in which correction data for performing correction with time is stored and a change-with-time-coping main-scanning-light-amount correcting unit 712 in which correction data of a main scanning direction adapted to an correction amount with time is stored are provided in the memory 71. The main control unit 70 reads out these correction data, sets a correction value with time in D/A converting units 73a and 73b, and sets a correction value of a main scanning direction in D/A converting units 73e and 73f.

In the first embodiment (D) (FIG. 30), the light-amount-change-with-time coping unit 710 in which correction data for performing correction with time is stored is provided in the memory 71. Correction data of a main scanning direction adapted to a correction amount with time is calculated by an arithmetic operation in a change-with-time-coping main-scanning-light-amount correcting unit 713 (a correction data calculating unit) of the main control unit 70 according to elapsed time. As in the first embodiment (C), the main control unit 70 sets a correction value with time in the D/A converting units 73a and 73b and sets a correction value of a main scanning direction in the D/A converting units 73e and 73f.

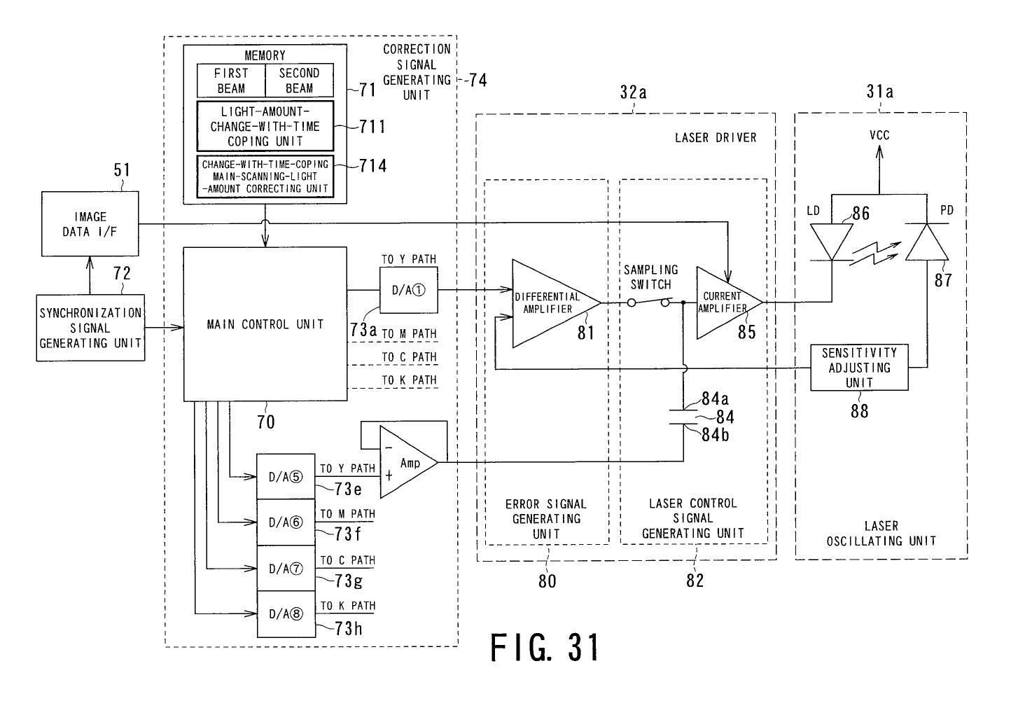

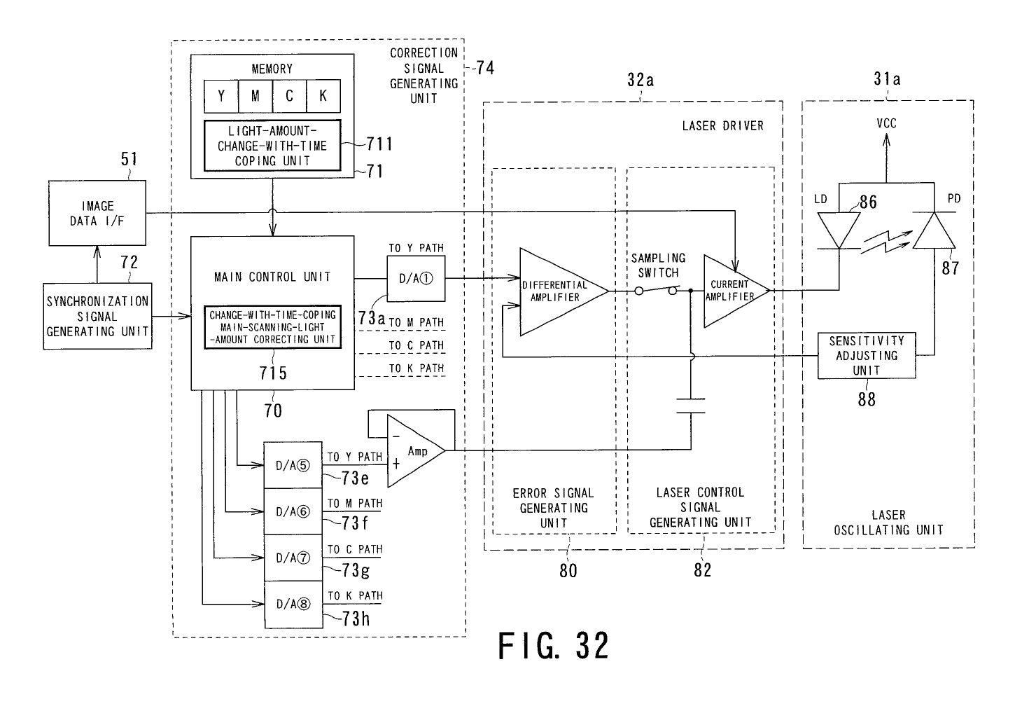

FIGS. 31 and 32 are diagrams showing examples of constitutions of the second embodiment (C) and the second embodiment (D) that realize the adaptive correction in the image forming apparatus 200a of the four beam system, respectively.

In the second embodiment (C) (FIG. 31), the light-amount-change-with-time coping unit 711 in which correction data for performing correction with time is stored and a change-with-time-coping main-scanning-light-amount correcting unit 714 in which correction data of a main scanning direction adapted to an correction amount with time is stored are provided in the memory 71. The main control unit 70 reads out these correction data, sets a correction value with time in D/A converting units 73a, 73b, 73c, and 73d, and sets a correction value of a main scanning direction in D/A converting units 73e, 73f, 73g, and 73h.

In the second embodiment (D) (FIG. 32), the light-amount-change-with-time coping unit 711 in which correction data for performing correction with time is stored is provided in the memory 71. Correction data of a main scanning direction adapted to a correction amount with time is calculated by an arithmetic operation in a change-with-time-coping main-scanning-light-amount correcting unit 715 (a correction data calculating unit) of the main control unit 70 according to elapsed time. As in the second embodiment (C), the main control unit 70 sets a correction value with time in the D/A converting units 73a, 73b, 73c, and 73d and sets a correction value of a main scanning direction in the D/A converting units 73e, 73f, 73g, and 73h.

As explained above, according to the laser beam scanning apparatus, the image forming apparatus, and the laser beam scanning method according to this embodiment, it is possible to fix laser beam intensity with respect to the main scanning direction on the photosensitive drum and correct a change in characteristics with time such as a fall in sensitivity of a photosensitive member.

The invention is not limited to the embodiments themselves. It is possible to modify and embody the elements without departing from the spirit of the invention when the invention is carried out. It is possible to form various inventions according to appropriate combinations of the plural components disclosed in the embodiments. For example, several components may be deleted from all the components described in the embodiments. Moreover, the components in the different embodiments may be appropriately combined.

What is claimed is:

1. A laser beam scanning apparatus comprising:
a laser oscillating unit that outputs a laser beam;
a laser beam scanning unit that performs scanning in a main scanning direction with a laser beam and irradiates the laser beam on a photosensitive member via an optical lens;
an error signal generating unit that monitors, in a predetermined period, intensity of a laser beam outputted from the laser oscillating unit and generates an error signal of an error between output intensity of the laser oscillating unit and a predetermined output reference value;
a correction signal generating unit that generates a correction signal for correcting output intensity of a laser beam according to a change in optical efficiency in the main scanning direction such that intensity of the laser beam in the main scanning direction on the photosensitive member is constant; and
a laser control signal generating unit that holds, during the image formation period, a reference signal generated on the basis of the error signal and applies the correction signal to the reference signal to generate a laser control signal for determining intensity of a laser beam outputted from the laser oscillating unit,
wherein the correction signal generated by the correction signal generating unit is a correction signal for correcting sensitivity of the photosensitive member including a change in the sensitivity with time and is a correction signal for further applying correction corresponding to a change in optical efficiency in the main scanning direction to output intensity of a laser beam with the change in the sensitivity with time corrected.

2. A laser beam scanning apparatus according to claim 1, wherein
the photosensitive member includes plural photosensitive members, and
the correction signals generated by the correction signal generating unit are plural correction signals for correcting intensity of a laser beam in the main scanning direction to be constant for each of the plural photosensitive members.

3. A laser beam scanning apparatus according to claim 1, wherein
the laser oscillating unit includes plural laser oscillating units, and
the correction signals generated by the correction signal generating unit are plural correction signals for correcting intensity of a laser beam in the main scanning direction of the photosensitive members to be constant for each of plural laser beams outputted from the plural laser oscillating units.

4. A laser beam scanning apparatus according to claim 1, wherein
the correction signal generating unit includes:
a storing unit in which correction data for correcting intensity of the laser beam along the main scanning direction is stored; and
a D/A converting unit that converts the correction data into the correction signal of an analog amount.

5. A laser beam scanning apparatus according to claim 1, wherein
the correction signal generating unit includes:
a correction data calculating unit that calculates correction data for correcting intensity of the laser beam along the main scanning direction; and
a D/A converting unit that converts the correction data calculated into the correction signal of an analog amount.

6. A laser beam scanning apparatus according to claim 1, wherein
the laser control signal generating unit includes:
a switch; and
a capacitor that has a charge/discharge terminal connected to the switch and a reference potential terminal,
in a predetermined period, the laser control signal generating unit generates the reference signal by closing the switch and charging and discharging the error signal at the charge/discharge terminal of the capacitor, and
in the image formation period, the laser control signal generating unit opens the switch to hold the reference signal in the capacitor and applies the correction signal to the reference potential terminal of the capacitor to generate the laser control signal.

7. An image forming apparatus comprising:
a photosensitive member;
a laser beam scanning apparatus that scans the photosensitive member with a laser beam in order to form an electrostatic latent image on the photosensitive member;
a developing unit that applies toner development to the photosensitive member on which an electrostatic latent image is formed and generates a developed image; and
a fixing unit that fixes the developed image,
wherein the laser beam scanning apparatus includes:
a laser oscillating unit that outputs a laser beam;
a laser beam scanning unit that performs scanning in a main scanning direction with a laser beam and irradiates the laser beam on a photosensitive member via an optical lens;
an error signal generating unit that monitors, in a predetermined period, intensity of a laser beam outputted from the laser oscillating unit and generates an error signal of an error between output intensity of the laser oscillating unit and a predetermined output reference value;
a correction signal generating unit that generates a correction signal for correcting output intensity of a laser beam according to a change in optical efficiency in the main scanning direction such that intensity of the laser beam in the main scanning direction on the photosensitive member is constant; and
a laser control signal generating unit that holds, during the image formation period, a reference signal generated on the basis of the error signal and applies the correction signal to the reference signal to generate a laser control signal for determining intensity of a laser beam outputted from the laser oscillating unit,
wherein the correction signal generated by the correction signal generating unit is a correction signal for correcting sensitivity of the photosensitive member including a change in the sensitivity with time and is a correction signal for further applying correction corresponding to a change in optical efficiency in the main scanning direction to output intensity of a laser beam with the change in the sensitivity with time corrected.

8. An image forming apparatus according to claim 7, wherein
the photosensitive member includes plural photosensitive members, and
the correction signals generated by the correction signal generating unit are plural correction signals for correcting intensity of a laser beam in the main scanning direction to be constant for each of the plural photosensitive members.

9. An image forming apparatus according to claim 7, wherein
the laser oscillating unit includes plural laser oscillating units, and
the correction signals generated by the correction signal generating unit are plural correction signals for correcting intensity of a laser beam in the main scanning direction of the photosensitive members to be constant for each of plural laser beams outputted from the plural laser oscillating units.

10. An image forming apparatus according to claim 7, wherein
the correction signal generating unit includes:
a storing unit in which correction data for correcting intensity of the laser beam along the main scanning direction is stored; and
a D/A converting unit that converts the correction data into the correction signal of an analog amount.

11. An image forming apparatus according to claim 7, wherein
the correction signal generating unit includes:
a correction data calculating unit that calculates correction data for correcting intensity of the laser beam along the main scanning direction; and
a D/A converting unit that converts the correction data calculated into the correction signal of an analog amount.

12. An image forming apparatus according to claim 7, wherein
the laser control signal generating unit includes:
a switch; and
a capacitor that has a charge/discharge terminal connected to the switch and a reference potential terminal,
in a predetermined period, the laser control signal generating unit generates the reference signal by closing the switch and charging and discharging the error signal at the charge/discharge terminal of the capacitor, and
in the image formation period, the laser control signal generating unit opens the switch to hold the reference signal in the capacitor and applies the correction signal to the reference potential terminal of the capacitor to generate the laser control signal.

13. A laser beam scanning method comprising:
outputting a laser beam from a laser oscillating unit;
scanning in a main scanning direction with a laser beam and irradiating the laser beam on a photosensitive member via an optical lens;
monitoring, in a predetermined period, intensity of a laser beam outputted from the laser oscillating unit;
generating an error signal of an error between output intensity of the laser oscillating unit and a predetermined output reference value;
generating a correction signal for correcting output intensity of a laser beam according to a change in optical efficiency in the main scanning direction such that intensity of the laser beam in the main scanning direction on the photosensitive member is constant; and
holding a reference signal generated on the basis of the error signal during the image formation period,;
applying the correction signal to the reference signal to generate a laser control signal for determining intensity of a laser beam outputted from the laser oscillating unit,
wherein the correction signal generated in the generating the correction signal step is a correction signal for correcting sensitivity of the photosensitive member including a change in the sensitivity with time and is a correction signal for further applying correction corresponding to a change in optical efficiency in the main scanning direction to output intensity of a laser beam with the change in the sensitivity with time corrected.

14. A laser beam scanning method according to claim 13, wherein
the photosensitive member includes plural photosensitive members, and
the correction signals generated in the generating the correction signal step are plural correction signals for correcting intensity of a laser beam in the main scanning direction to be constant for each of the plural photosensitive members.

15. A laser beam scanning method according to claim 13, wherein
the laser oscillating unit includes plural laser oscillating units, and
the correction signals generated in the generating the correction signal step are plural correction signals for correcting intensity of a laser beam in the main scanning direction of the photosensitive members to be constant for each of plural laser beams outputted from the plural laser oscillating units.

16. A laser beam scanning method according to claim 13, wherein
the generating the correction signal step includes:
storing correction data for correcting intensity of the laser beam along the main scanning direction; and
converting the correction data into the correction signal of an analog amount.

17. A laser beam scanning method according to claim 13, wherein
the generating the correction signal step includes:
calculating correction data for correcting intensity of the laser beam along the main scanning direction; and
converting the correction data calculated into the correction signal of an analog amount.

18. A laser beam scanning method according to claim 13, wherein
in a predetermined period, the reference signal is generated by closing a switch and charging and discharging the error signal at a charge/discharge terminal of a capacitor, and
in the image formation period, the switch is opened to hold the reference signal in the capacitor and applies the correction signal to a reference potential terminal of the capacitor to generate the laser control signal.
